(19) United States
(12) Patent Application Publication
(10) Pub. No.: US 2008/0295137 A1
(43) Pub. Date: Nov. 27, 2008

(54) Digital Video Broadcasting-Satellite Multi-Input Receiving Circuit and Associated Method

(76) Inventor: ShouFang CHEN, Chu Pei (TW)

Correspondence Address: TROXELL LAW OFFICE PLLC, SUITE 1404, 5205 LEESBURG PIKE, FALLS CHURCH, VA, 22041, US

(21) Appl. No.: 12/124,367

(22) Filed: May 21, 2008

(30) Foreign Application Priority Data
May 22, 2007 (TW) 096118107

(51) Int. Cl. H04N 7/20

(52) U.S. Cl. 725/70

(57) ABSTRACT

A digital video broadcasting-satellite (DVB-S) multi-input receiving circuit and an associated method are provided to receive satellite input signals provided by a plurality of low noise blocks (LNB), thereby reducing the cost of DVB-S receivers. The DVB-S multi-input receiving circuit includes a selection circuit and a combiner. The selection circuit includes a plurality of signal paths for conveying a plurality of satellite input signals, and enables one of the signal paths to output one of the satellite input signals. The combiner combines the signal paths into a single signal path, which is coupled to a DVB-S tuner.

### BACKGROUND OF INVENTION

1. Field of the Invention

The present invention relates to Digital Video Broadcasting-Satellite (DVB-S), and more particularly to a DVB-S multi-input receiving circuit and associated method.

2. Description of the Prior Art

The DVB-S standard, widely used in digital satellite television transmission, applies a low noise block (LNB) to downconvert the signal of each satellite channel, e.g. video signal, and then sends the downconverted signal to a respective DVB-S receiver for subsequent processing. FIG. 1A shows a conventional DVB-S system, which receives signals from two different satellites respectively through antennas 14, 19 and LNBs 12, 13, and then sends the received signals to DVB-S receivers 10, 11 respectively. In other words, the satellite signal received by each LNB requires a separate DVB-S receiver for processing, which results in high installation cost for the DVB-S system.

For example, when the DVB-S system is installed indoors to provide satellite television service in two rooms, it requires four DVB-S receivers if two LNBs are utilized. As shown in FIG. 1B, the LNBs 12, 13 send the satellite signals to both rooms through splitters 17, 18, while each room must be equipped with two DVB-S receivers (labeled as 10, 11, 15 and 16) in order to receive and process the complete satellite signals.

### SUMMARY OF INVENTION

It is therefore one objective of the present invention to provide a DVB-S multi-input receiving circuit and an associated method that can receive satellite input signals from multiple LNBs, thereby reducing the cost of the DVB-S system.

A DVB-S multi-input receiving circuit is provided. The DVB-S multi-input receiving circuit comprises: a selection circuit including a first signal path and a second signal path, the first signal path receiving and conveying a first satellite input signal, the second signal path receiving and conveying a second satellite input signal, wherein the selection circuit enables one of the first signal path and the second signal path according to a control signal to output one of the first satellite input signal and the second satellite input signal; and a combiner, coupled to the selection circuit, for combining the first signal path and the second signal path into a single signal path, and coupling the signal path to a DVB-S tuner.

Another DVB-S multi-input receiving circuit is provided. The another DVB-S multi-input receiving circuit comprises: a radio frequency (RF) switch for receiving a first satellite input signal and a second satellite input signal from a first LNB and a second LNB respectively, and selectively outputting one of the first and second satellite input signals according to a control signal; and a control unit for generating the control signal.

A DVB-S signal receiving method is further provided. The DVB-S signal receiving method comprises steps of: receiving and conveying a plurality of satellite input signals via a plurality of signal paths; enabling one of the signal paths according to a control signal; and combining the signal paths into a single signal path for output.

### BRIEF DESCRIPTION OF THE DRAWINGS

FIG. 1A shows a conventional DVB-S system.

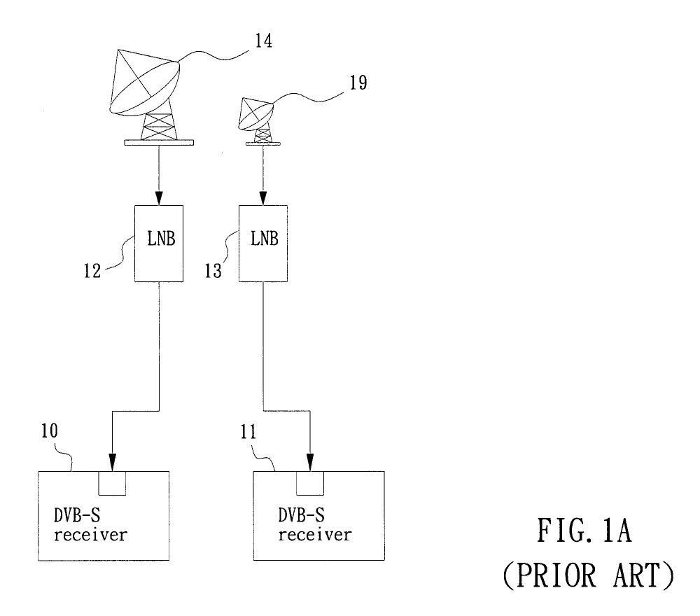

FIG. 1B shows an example of applying the scheme in FIG. 1A indoors.

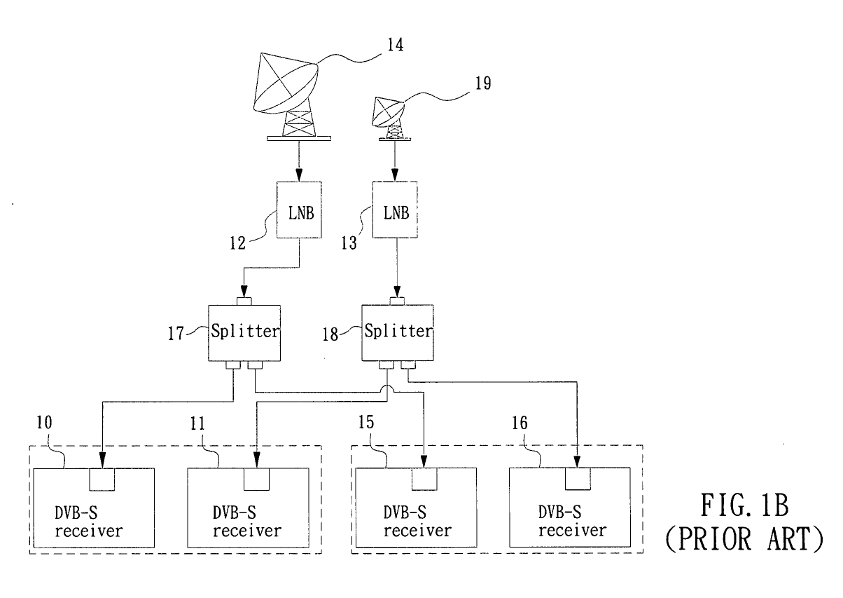

FIG. 2 shows a scheme of a DVB-S system according to an embodiment of the invention.

FIG. 3 is a block diagram of a DVB-S receiving circuit according to a preferred embodiment of the invention.

FIG. 4A is a block diagram of the DVB-S receiving circuit according to another embodiment of the invention.

FIG. 4B is a detailed circuit diagram of the DVB-S receiving circuit of FIG. 4A.

FIG. 5 is a block diagram of the DVB-S receiving circuit according to another embodiment of the invention.

FIG. 6 is a block diagram of a DVB-S receiving circuit according to another embodiment of the invention.

FIG. 7 is a flow chart of a DVB-S signal receiving method according to one embodiment of the invention.

### DETAILED DESCRIPTION

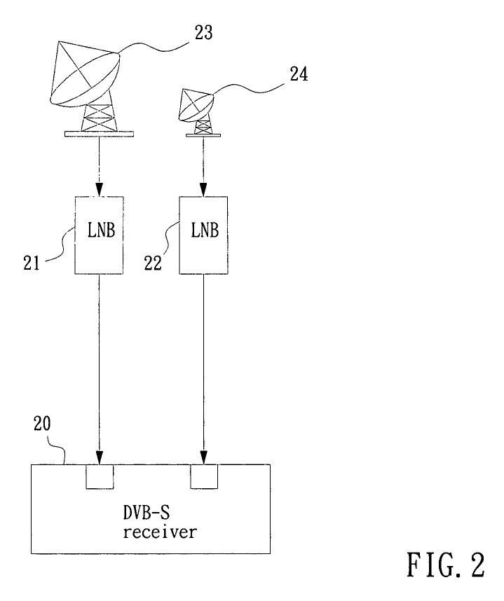

FIG. 2 shows a scheme of a DVB-S system according to an embodiment of the invention, where LNBs 21, 22 receive signals from different satellites through antennas 23, 24 and downconvert the received signals to output a first satellite input signal and a second satellite input signal respectively. A DVB-S receiver 20 with two inputs receives the first satellite input signal and the second satellite input signal from the LNBs 21, 22 respectively.

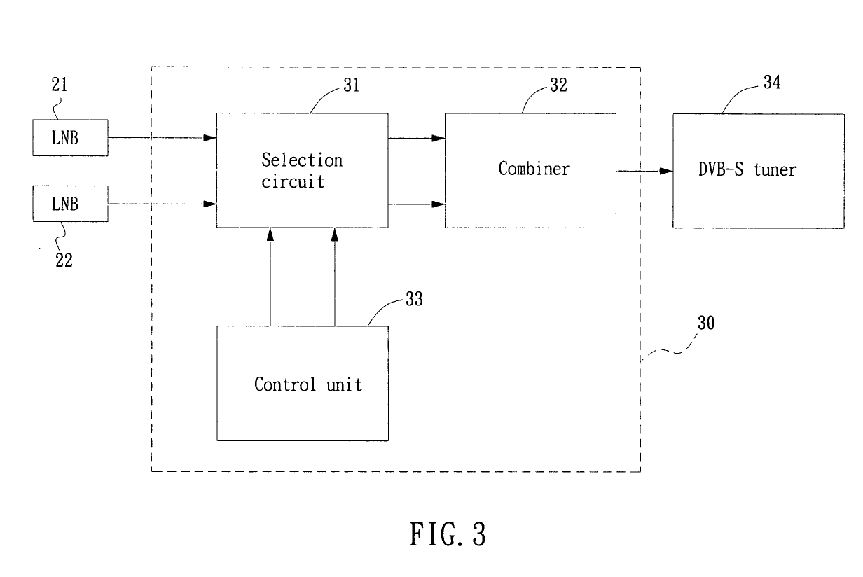

FIG. 3 is a block diagram of a DVB-S receiving circuit 30 according to a preferred embodiment of the invention, where the DVB-S receiving circuit 30 and a DVB-S tuner 34 are disposed in the DVB-S receiver 20 of FIG. 2. The DVB-S receiving circuit 30 includes a selection circuit 31, a combiner 32, and a control unit 33. The selection circuit 31 comprises a first signal path and a second signal path. The first signal path conveys the first satellite input signal, and the second signal path conveys the second satellite input signal. The selection circuit 31 enables one of the first signal path and the second signal path according to a control signal generated by the control unit 33 to output one of the first satellite input signal and the second satellite input signal. For example, if the first signal path is enabled, the first satellite input signal is output and the second signal path is in a disabled state without outputting the second satellite input signal, and vice versa. The combiner 32, coupled to the selection circuit 31, combines the first signal path and the second signal path of the selection circuit 31 into a single signal path, by which coupling the combiner 32 to the DVB-S tuner 34. The combiner 32 provides signal isolation at a low cost to reduce the interference between the first and second signal paths. For example, the length of the first signal path within the combiner 32 is one quarter or one half the wavelength of the first satellite input signal, and the length of the second signal path within the combiner 32 is one quarter or one half the wavelength of the second satellite input signal, thereby isolating the two signal paths.

The control unit 33 generates the control signal to the selection circuit 31 according to the user control, e.g. choosing one certain LNB for the corresponding satellite input signal. The control unit 33 further provides a power signal, which is respectively sent to the LNBs 21, 22 via the selection circuit 31 to supply electric power. For example, the control unit 33 is a microcontroller.

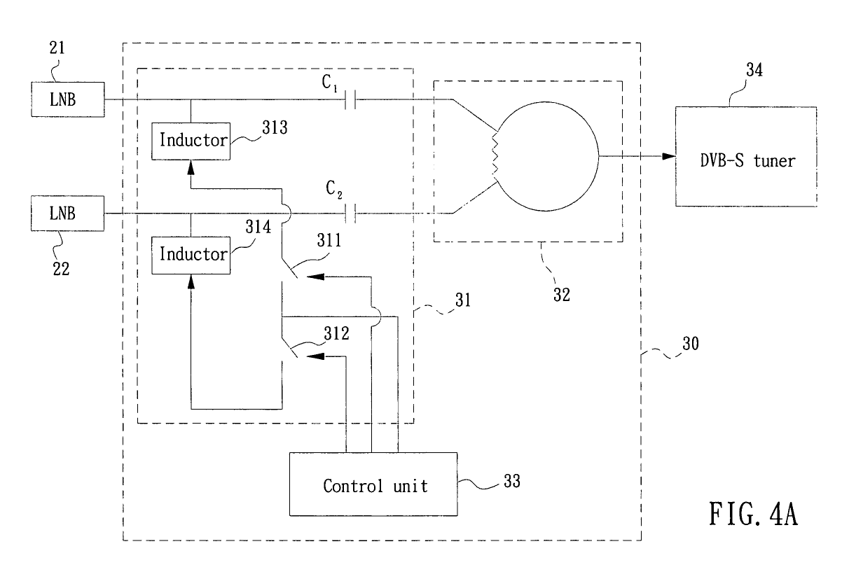

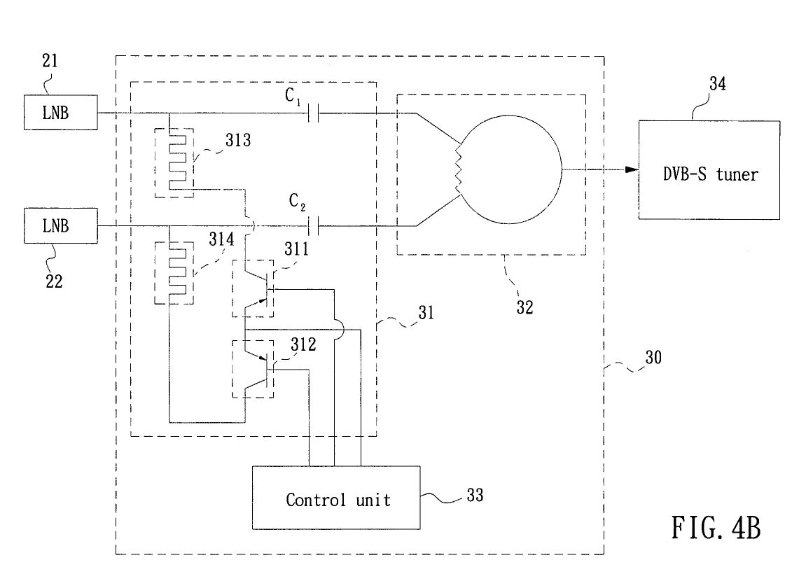

FIG. 4A is a block diagram of the DVB-S receiving circuit 30 of FIG. 3 according to one embodiment of the present invention. The selection circuit 31 comprises switches 311, 312, capacitors C₁, C₂, and inductors 313, 314. The power signal provided by the control unit 33 is delivered to the LNBs 21, 22 via the switches 311, 312 respectively. The capacitors C₁, C₂ are disposed respectively in the first and second signal paths to isolate the direct current (DC) signals in the first and second signal paths, thereby keeping them from being fed into the combiner 32. In this embodiment, the capacitors C₁, C₂ isolate the DC power sent from the control unit 33 to the first and second signal paths via the switches 311, 312, so as to prevent the DC power from being fed into the combiner 32. The control signal generated by the control unit 33 includes a first enable signal and a second enable signal, which are sent respectively to the switches 311, 312 to control their ON/OFF status. For example, when the first enable signal is asserted to conduct the switch 311, the second enable signal is deasserted to disconnect the switch 312. Therefore, the LNB 21 operates with the power supplied by the power signal, while the LNB 22 is disabled due to no power. Thus, the first signal path is enabled, while the second signal path is disabled, and vice versa. The inductor 313 is coupled between the switch 311 and the LNB 21 to isolate the alternating current (AC) signal in the first signal path; and the inductor 314 is coupled between the switch 312 and the LNB 22 to isolate the AC signal in the second signal path.

The switches 311, 312 can be transistor switches, and the inductors 313, 314 can be trace inductors. As shown in FIG. 4B, the switches 311, 312 are BJT transistors, and the first and second enable signals are sent to the bases of the BJT transistors to control their ON/OFF status. The switches 311, 312 can also be implemented as MOS transistors. In such case, the first and second enable signals control the gates of the MOS transistors.

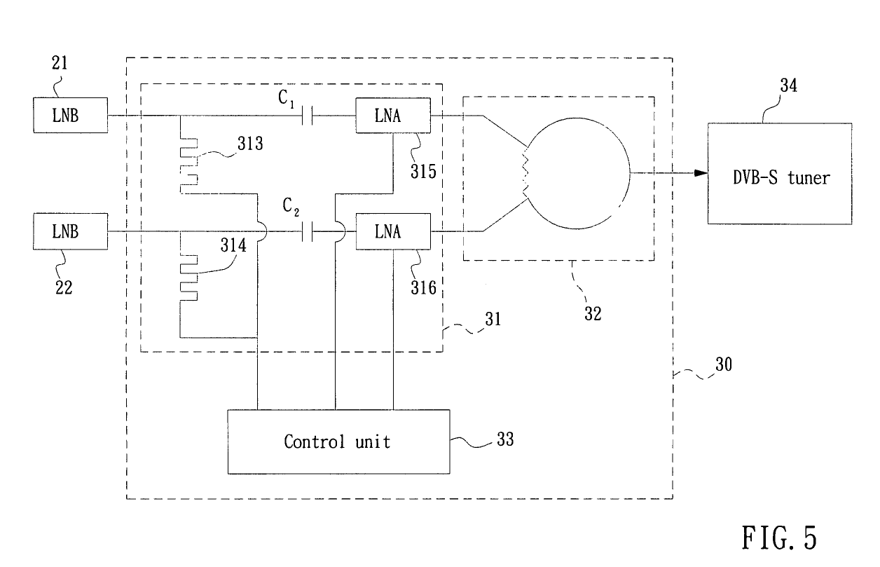

FIG. 5 is a block diagram of the DVB-S receiving circuit 30 of FIG. 3 according to another embodiment of the present invention. The selection circuit 31 comprises low noise amplifiers (LNA) 315, 316 disposed respectively in the first and second signal paths to amplify the first and second satellite input signals with reduced noise in the two signal paths. The control signal provided by the control unit 33 also includes the first enable signal and the second enable signal, which respectively enter the LNAs 315, 316 to selectively enable the LNAs 315, 316. For example, the first enable signal enables the LNA 315 and the second enable signal disables the LNA 316, so as to enable the first signal path while disable the second signal path, and vice versa.

Preferably, the combiner 32 and the DVB-S tuner 34 are integrated in an integrated circuit (IC). Alternatively, the DVB-S receiving circuit 30 and the DVB-S tuner 34 are integrated in an IC, thereby reducing the size of the whole DVB-S receiver 20.

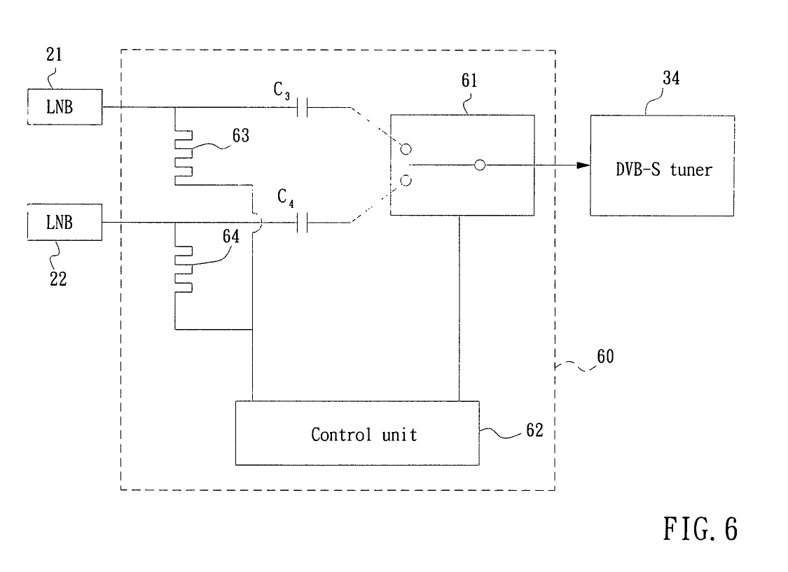

FIG. 6 is a block diagram of a DVB-S receiving circuit 60 according to another embodiment of the invention The DVB-S receiving circuit 60 comprises an RF switch 61, a control unit 62, capacitors C₃, C₄, and trace inductors 63, 64. The LNBs 21, 22 respectively transmit the first and second satellite input signals into the RF switch 61 via the capacitors C₃, C₄. One of the first and second satellite input signals is then selected, according to a control signal generated by the control unit 62, for outputting to the DVB-S tuner 34. The control unit 62 also supplies a DC power signal to the LNBs 21, 22 via the trace inductors 63, 64, respectively. The control unit 62 can be a microcontroller, and the RF switch 61 and the DVB-S tuner 34 can be integrated in an IC.

The embodiments in FIGS. 2˜6 can be extended to have more than two inputs. For example, the selection circuit 31 of FIG. 3 can include N signal paths (N≧2) for receiving and conveying N satellite input signals, and according to a control signal, enable one of the N signal paths to output one of the N satellite input signals. The combiner 32 combines the N signal paths into a single signal path and couples the single signal path to the DVB-S tuner 34. Preferably, the length of each signal path in the combiner 32 is one quarter or one half the wavelength of the satellite input signal conveyed in the signal path.

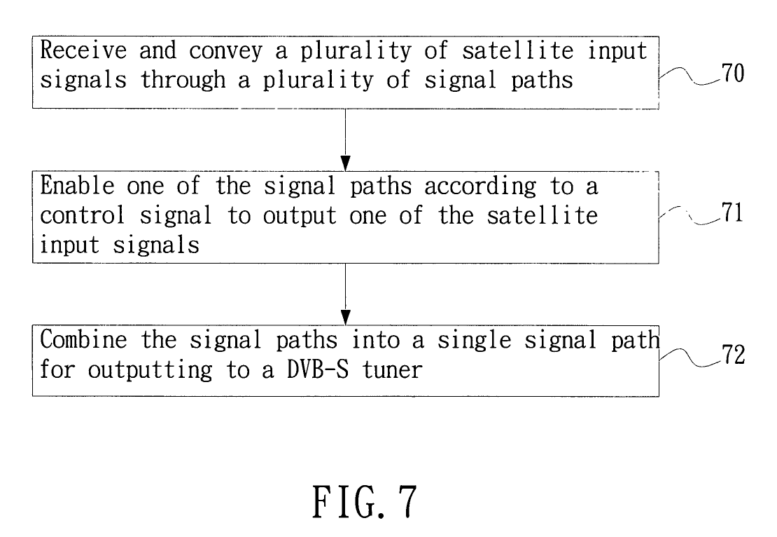

FIG. 7 is a flow chart of a DVB-S signal receiving method according to one embodiment of the invention, which includes the following steps:

Step 70: Receive and convey a plurality of satellite input signals through a plurality of signal paths.

Step 71: Enable one of the signal paths according to a control signal to output one of the satellite input signals.

Step 72: Combine the signal paths into a single signal path for outputting to a DVB-S tuner.

While the present invention has been shown and described with reference to the preferred embodiments thereof and in terms of the illustrative drawings, it should not be considered as limited thereby. Various possible modifications and alterations could be conceived of by persons skilled without departing from the scope and the spirit of the present invention.

What is claimed is:

1. A digital video broadcasting-satellite (DVB-S) multi-input receiving circuit comprising:
a selection circuit including a first signal path and a second signal path, the first signal path receiving and conveying a first satellite input signal, the second signal path receiving and conveying a second satellite input signal, wherein the selection circuit enables one of the first signal path and the second signal path according to a control signal to output one of the first satellite input signal and the second satellite input signal; and
a combiner, coupled to the selection circuit, for combining the first signal path and the second signal path into a single signal path, and coupling the single signal path to a DVB-S tuner.

2. The DVB-S multi-input receiving circuit of claim 1, further comprising:
a control unit for generating the control signal.

3. The DVB-S multi-input receiving circuit of claim 2, wherein the control unit is a microcontroller.

4. The DVB-S multi-input receiving circuit of claim 2, wherein the first satellite input signal and the second satellite input signal are provided by a first low noise block (LNB) and a second LNB respectively, the selection circuit comprises a first switch and a second switch, the control unit provides a power signal to the first LNB and the second LNB via the first switch and the second switch respectively, and the control signal comprises a first enable signal and a second enable signal for respectively controlling the first switch and the second switch.

5. The DVB-S multi-input receiving circuit of claim 4, wherein the selection circuit comprises a first inductor and a second inductor, and the power signal is provided to the first LNB and the second LNB via the first inductor and the second inductor respectively.

6. The DVB-S multi-input receiving circuit of claim 5, wherein the first inductor and the second inductor are trace inductors.

7. The DVB-S multi-input receiving circuit of claim 4, wherein the first switch and the second switch are transistor switches.

8. The DVB-S multi-input receiving circuit of claim 1, wherein the selection circuit comprises a first low noise amplifier (LNA) and a second LNA disposed in the first signal path and the second signal path respectively, wherein the control signal comprises a first enable signal and a second enable signal for enabling the first LNA and the second LNA respectively.

9. The DVB-S multi-input receiving circuit of claim 1, wherein the selection circuit comprises a first capacitor and a second capacitor which are disposed in the first signal path and the second signal path respectively to isolate direct current (DC) signals in the first signal path and the second signal path respectively.

10. The DVB-S multi-input receiving circuit of claim 1, wherein the combiner and the DVB-S tuner are integrated in an integrated circuit (IC).

11. The DVB-S multi-input receiving circuit of claim 1, wherein the DVB-S multi-input receiving circuit and the DVB-S tuner are integrated in an integrated circuit (IC).

12. The DVB-S multi-input receiving circuit of claim 1, wherein a length of the first signal path within the combiner is one quarter a wavelength of the first satellite input signal.

13. The DVB-S multi-input receiving circuit of claim 1, wherein a length of the second signal path within the combiner is one quarter a wavelength of the second satellite input signal.

14. A digital video broadcasting-satellite (DVB-S) multi-input receiving circuit comprising:
a radio frequency (RF) switch for receiving a first satellite input signal and a second satellite input signal from a first low noise block (LNB) and a second LNB respectively, and selectively outputting one of the first satellite input signal and the second satellite input signal according to a control signal; and
a control unit for generating the control signal.

15. The DVB-S multi-input receiving circuit of claim 14, wherein the RF switch outputs one of the first satellite input signal and the to second satellite input signal to a DVB-S tuner, and the RF switch and the DVB-S tuner are integrated in an integrated circuit (IC).

16. The DVB-S multi-input receiving circuit of claim 14, wherein the control unit provides a power signal to the first LNB and the second LNB respectively, and the power signal is coupled to the first LNB and the second LNB via a first inductor and a second inductor respectively.

17. The DVB-S multi-input receiving circuit of claim 16, wherein the first inductor and the second inductor are trace inductors.

18. In a digital video broadcasting-satellite (DVB-S) signal receiving circuit, a control method comprising:
receiving and conveying a plurality of satellite input signals via a plurality of signal paths;
enabling one of the signal paths according to a control signal; and
combining the signal paths into a single signal path.
